(19) United States
(12) Patent Application Publication
(10) Pub. No.: US 2007/0101112 A1
(43) Pub. Date: May 3, 2007

(54) Embedded device detecting system and related method

(75) Inventor: Chih-Wei Chen, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/259,100

(22) Filed: Oct. 27, 2005

(51) Int. Cl. G06F 15/177

(52) U.S. Cl. 713/1

(57) ABSTRACT

An embedded device detecting system and related method are proposed. The embedded device detecting method judges identification data inputted from an input module and generates corresponding data access privilege according to the identification data, and executes a processing program corresponding to the data access privilege and stored in a storing module after receiving the data access privilege, the processing program at least including an operation processing program and a detection processing program. Through the use of the embedded device detecting system and related method, it can generate the corresponding processing program according to the data access privilege merely by virtue of a built-in storing module, a privilege judging module and an operation processing module, and without connecting to network distant server in addition or replacing flash ROM, thereby significantly upgrading the convenience and efficiency for detecting the embedded device.

### BACKGROUND OF THE INVENTION

1. Field of the Invention

The present invention relates generally to an embedded device detecting system and related method and, more particularly, to an embedded device detecting system and related method applied to an electronic device with an embedded device.

2. Description of Related Art

With the coming of the PC information application age, consumers pay more and more attention to the product's function and stability. It is required that not only hardware is condensable, capable of saving electricity and handsome, but also software is stable and efficient. Therefore, the embedded device satisfied for the above requirement is emerged as required. The electronic devices, such as computer, mobile telephone, digital video, personal digital assistant (PDA) and the like, fall within the scope of embedded device.

A modern embedded device includes neither an integrated input/output interface, such as keyboard, mouse, floppy disk, CD-ROM, nor a display unit, such as liquid crystal display (LCD), cathode ray tube (CRT). Moreover, the embedded device has only one flash read-only memory (ROM), which is used for storing an operating system (OS) program and an applications program of the embedded device. Therefore, after the embedded device is produced and assembled, a user can not employ the embedded device itself to execute a relatively complex detection processing program. The user can do nothing but connects the OS program to a pre-installed server through a network for copying the detection processing program to the embedded device by the server, to performing a detection process. During the detecting process, an additional network device is required to detect the embedded device, so the detecting process is relatively complex, and cost for the detecting device is high, thereby the detecting process is quite complicated. While after producing and assembling, another embedded device detecting method executes the detection processing program of memory on the power-on state to detect by inserting a flash ROM with detection processing program, and pulls out the flash memory after finishing detection, replaces back the original flash memory for recovering the original system. However, a flash ROM with detection processing program is inserted and pulled out on the power-on state, which making the system easily stopped and the detection processing program stored in the flash memory damaged, and the complex process for pulling and replacing ROM is even quite inconvenient.

As described above, the user can not employ the embedded device itself to detect. Therefore, there exists a strong need in the art to upgrade the efficiency when detecting the embedded device.

### SUMMARY OF THE INVENTION

Accordingly, it is an objective of the present invention to solve the drawbacks of the aforementioned conventional technology by providing an embedded device detecting system and related method for an embedded device to detect itself.

It is another objective of the present invention to provide an embedded device detecting system and related method capable of keep integrity of information of a detection processing program.

It is a further objective of the present invention to provide an embedded device detecting system and related method which provides the users for detecting the embedded device for production and maintenance.

It is yet another objective of the present invention to provide an embedded device detecting system and related method which reduces cost for a detecting device.

In order to attain the object mentioned above and the others, an embedded device detecting system and related method are provided according to the present invention. The embedded device detecting system according to the present invention at least includes an input module for inputting data at least including identification data, a storing module for storing a plurality of processing programs at least including an operation processing program and a detection processing program, a privilege judging module for judging the identification data inputted from the input module and generating corresponding data access privilege according to the identification data, and an operation processing module for executing the processing program corresponding to the data access privilege and stored in the storing module after receiving the data access privilege generated by the privilege judging module according to the identification data.

In one state of the present invention, the embedded device detecting system further includes a display module for displaying the data inputted from the input module and data generated by the operation processing module after executing a processing program.

In another state of the present invention, the storing module further includes a first data storing region for storing the operation processing program, and a second data storing region for storing the detection processing program.

In another state of the present invention, the detection processing program includes a production detection processing program and a maintenance detection processing program.

In another state of the present invention, when one of the production detection processing program and the maintenance detection processing program is running, the other will not be executed.

The embedded device detecting method according to the present invention at least includes judging an identification data inputted from an input module, and generating corresponding data access privilege according to the identification data; and executing a processing program corresponding to the data access privilege and stored in the storing module after receiving the data access privilege, the processing program at least including one of an operation processing program and a detection processing program.

In one state of the present invention, the storing module includes a first data storing region for storing the operation processing program, and a second data storing region for storing the detection processing program.

In another state of the present invention, the detection processing program includes a production detection processing program and a maintenance detection processing program.

In a further state of the present invention, when one of the production detection processing program and the maintenance detection processing program is running, the other will not be executed.

As described above, the embedded device detecting system and related method according to the present invention can generate the corresponding processing program according to the data access privilege merely by virtue of the built-in storing module, privilege judging module and operation processing module, and without connecting to network distant server in addition or replacing flash ROM, thereby significantly upgrading the convenience and efficiency for detecting the embedded device.

### BRIEF DESCRIPTION OF DRAWINGS

FIG. 1 depicts a functional block diagram of an embedded device detecting system of the preferred embodiment according to the present invention.

FIG. 2 depicts a flow chart of an embedded device detecting method corresponding to the embedded device detecting system shone in FIG. 1 according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

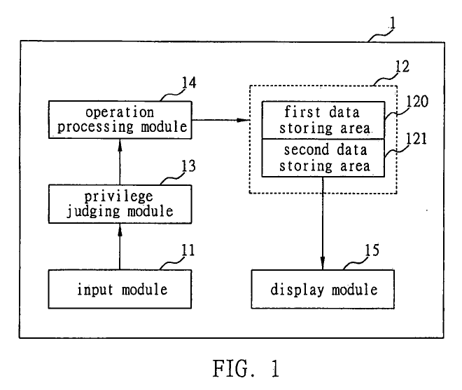

Please refer to FIG. 1, which is a functional block diagram of an embedded device detecting system 1 of the preferred embodiment according to the present invention. The embedded device detecting system 1 according to the present invention is applied to an electronic device with an embedded device, such as a computer, a mobile telephone, a digital video recorder, a PDA or a personal stereo or the like. The embedded device detecting system 1 according to the present invention at least comprises an input module 11, a storing module 12, a privilege judging module 13 and an operation processing module 14.

Note that the embedded device detecting system 1 according to the present invention further comprises other kinds of function units. In order to simplify the drawings and description, the structure herein is merely illustrated the component pertaining to the present invention, the necessary components of a similar electronic device when operating, e.g., the hard structure of memory, storage location of hardware or the like, are not illustrated in the drawings.

In the exemplary embodiment, the electronic device, after being powered-on and entering a power-on procedure, runs a power on self testing (POST) procedure with a BIOS program, and then runs an OS program, e.g., Linux OS, for a user to detect the embedded device under the OS program. Such a process from the power-on procedure to the POST procedure is known by the skilled, further description hereby omitted.

The input module 11 of the embedded device detecting system 1 can be, e.g., a keyboard, a mouse, a lightpen, all of which allow a user to input data, such as the user's account and password.

In the exemplary embodiment, the storing module 12 is a flash ROM, which is used for storing information of a processing program. The storing module 12 comprises a first data storing region 120 for storing the information of the operation processing program, and a second data storing region 121 for storing the information of detection processing program. In the embodiment, the first data storing region 120 is used to store the operation processing program, e.g., an OS program and a system application program, and the second data storing region 121 is used to store a production detection processing program and a maintenance detection processing program.

The privilege judging module 13 is used to judge identification data, e.g., accounts, passwords and the like, inputted from the input module 11, and generate corresponding data access privilege according to the identification data, so as to judge the information stored in the storing module 12.

The operation processing module 14 is used to execute a processing program corresponding to the data access privilege and stored in the storing module 12 after receiving the data access privilege generated by the privilege judging module 13 according to the identification data, making the embedded device detecting system 1 enter a processing environment corresponding to the data access privilege, e.g., a general mode or a detecting mode. In the exemplary embodiment, the operation processing module 14 is a central processing unit (CPU). When the privilege judging module 13 judges that the user is one of operating personnel and maintenance personnel, the operation processing module 14 executes the detection processing program stored in the storing module 12, and enters the detecting mode for the user to perform a production detecting operation or/and a maintenance detection operation; otherwise, the operation processing module 14 enters the general mode for the user such as consumer to perform operation with general function.

In the exemplary embodiment, before an embedded device leaves a factory, a user, e.g., detection personnel, can employ the embedded device detecting system 1 according to the present invention to enter the production detecting mode, so as to detect that whether the embedded device works well or not. In other words, when the embedded device comes up with any problem after leaving the factory, the user, e.g., maintenance personnel, can enter the maintenance detecting mode, so as to maintain the embedded device.

In another exemplary embodiment, the embedded device detecting system 1 according to the present invention further comprises a display module 15 which is used to display data inputted from the input module 11 and data generated by the operation processing module 14 after executing the processing program, the data able to be, e.g., production or maintenance detecting data. The display module 15 merely displays one of production detecting data and maintenance detecting data at the same time. If the display module 15 displays production detecting mode, which allows the user to perform the production detecting operation only, the display module 15 can not display maintenance detecting mode. On the other hand, if the display module 15 displays the maintenance detecting mode, which allows the user to perform the maintenance detecting operation only, the display module 15 can not display the production detecting mode.

Through storing production and maintenance program at the same time in the storing module 12, the user can perform production detecting before issuing the embedded device, or perform maintenance detecting when the embedded device comes up problem hereafter.

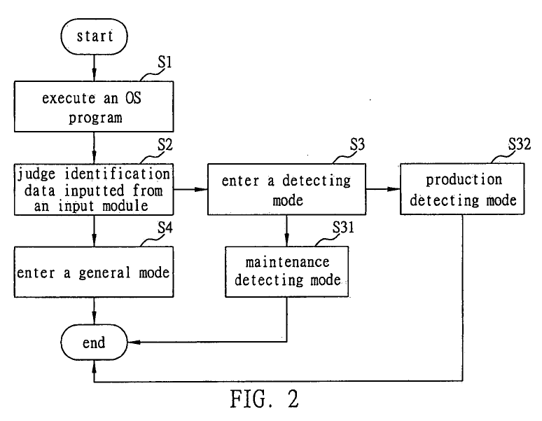

Please refer to FIG. 2, which is a flow chart of an embedded device detecting method corresponding to the embedded device detecting system 1 according to the present invention. The embedded device detecting method comprises the following steps.

In step S1, the OS program, e.g., Linux OS, stored in the storing module 12 is executed. The electronic device therefore is allowed to enter the OS program. Then proceed to step S2.

In step S2, the identification data such as accounts and password inputted from the input module 11 is judged with the use of the privilege judging module 13 of the electronic device. If the identification data are judged to be detection personnel's accounts and passwords, proceed to step S3, or proceed to step S4 to make the electronic device enter the general mode for the user to perform general operation.

In step S3, the detecting mode is entered to judge whether the data inputted by the user is production or maintenance data. If the data inputted by the user corresponds to the production detection personnel, proceed to step S31 to enter the production detecting mode for the user (e.g., operating personnel) to perform the production detecting operation of the embedded device, or proceed to step S32 to entering the maintenance detecting mode for the user (e.g., maintenance personnel) to perform maintenance detecting operation of the embedded device. In the exemplary embodiment, when the operation detecting is running, the maintenance detecting will not be executed; On the other hand, when the maintenance detecting is running, the operation detecting will not be executed.

In another exemplary embodiment, the embedded device detecting method according to the present invention further comprises displaying the data inputted from the input module 11 and data generated by operation processing module 14 after executing a processing program on the display module 15, the data should be, e.g., production or maintenance detecting data.

As described above, the embedded device detecting system and related method according to the present invention can generate the corresponding processing program according to the data access privilege merely by virtue of the built-in storing module, privilege judging module and operation processing module, and without connecting to network distant server in addition or replacing flash ROM, thereby significantly upgrading convenience and efficiency for detecting the embedded device.

The above-described exemplary embodiments are to describe various objects and features of the present invention as illustrative and not restrictive of the scope of the essential technical content according to the present invention, the essential technical content of the present invention is broadly defined in the appended claim, if the exemplary embodiments or method implemented by any one are completely identical to the following claim or only an equivalent change of the following claim, all that is considered to fall with the scope of the invention.

What is claimed is:

1. An embedded device detecting system built in an embedded device, the embedded device detecting system comprising:
an input module for inputting data, the data at least comprising identification data;
a storing module for storing a plurality of processing programs, the processing programs at least comprising an operation processing program and a detection processing program;
a privilege judging module for judging the identification data inputted from the input module and generating corresponding data access privilege according to the identification data; and
an operation processing module for executing a processing program corresponding to the data access privilege and stored in the storing module after receiving the data access privilege generated by the privilege judging module according to the identification data.

2. The embedded device detecting system of claim 1 further comprising a display module for displaying the data inputted from the input module and data generated by the operation processing module after executing a processing program.

3. The embedded device detecting system of claim 1, wherein the storing module comprises:
a first data storing region for storing the operation processing program; and
a second data storing region for storing the detection processing program.

4. The embedded device detecting system of claim 1, wherein the detection processing program comprises a production detection processing program and a maintenance detection processing program.

5. The embedded device detecting system of claim 4, wherein when one of the production detection processing program and the maintenance detection processing program is running, the other will not be executed.

6. The embedded device detecting system of claim 1, wherein the operation processing program is an operating system (OS) program and a system applications program.

7. The embedded device detecting system of claim 6, wherein the OS program is Linux.

8. The embedded device detecting system of claim 1, wherein the identification data is a user's account and password.

9. The embedded device detecting system of claim 1, wherein the storing module is flash read-only memory (ROM).

10. An embedded device detecting method applied in an embedded device, comprising:
judging identification data inputted from an input module, and generating corresponding data access privilege according to the identification data; and
executing a processing program corresponding to the data access privilege and stored in a storing module after receiving the data access privilege, the processing program at least comprising an operation processing program and a detection processing program.

11. The embedded device detecting method of claim 10, wherein the storing module comprises:
a first data storing region for storing the operation processing program; and
a second data storing region for storing the detection processing program.

12. The embedded device detecting method of claim 11, wherein the detection processing program comprises a production detection processing program and a maintenance detection processing program.

13. The embedded device detecting method of claim 12, wherein when one of the production detection processing program and the maintenance detection processing program is running, the other will not be executed.

14. The embedded device detecting method of claim 10, wherein the operation processing program is an OS program and a system applications program.

15. The embedded device detecting method of claim 14, wherein the OS program is Linux.

16. The embedded device detecting method of claim 10, wherein the identification data is a user's account and password.

17. The embedded device detecting method of claim 10, wherein the storing module is a flash ROM.
